(19) United States
(12) Patent Application Publication
(10) Pub. No.: US 2023/0366263 A1
(43) Pub. Date: Nov. 16, 2023

(54) ROLL-UP DOOR AND SYSTEM INCLUDING SAME

(71) Applicant: SteelBlue Building Components, LLC, Pittsburgh, PA (US)

(72) Inventors: Gary Paul Brunette, Pittsburgh, PA (US); Brad Louis Astolos, Pittsburgh, PA (US)

(21) Appl. No.: 18/196,317

(22) Filed: May 11, 2023

Related U.S. Application Data
(60) Provisional application No. 63/364,712, filed on May 13, 2022.

(51) Int. Cl. E06B 9/17; E06B 9/62; E06B 9/174

(52) U.S. Cl. CPC E06B 9/17023; E06B 9/62; E06B 9/174; E06B 9/58

(57) ABSTRACT

A roll-up door system including a hood assembly, an axle-drive assembly extending through the hood assembly, and a roll-up door coupled to the axle-drive assembly is disclosed. The hood assembly comprises a first end panel, a second end panel, and support angles coupled to the first end panel and the second end panel. The axle-drive assembly is rotatable relative to the hood assembly to transition the roll-up door between a stored state in which the roll-up door is wound around the axle-drive assembly within the hood assembly and a deployed state in which the roll-up door extends outside of the hood assembly.

### CROSS-REFERENCE TO RELATED APPLICATION

This application claims the benefit of U.S. Provisional Patent Application Ser. No. 63/364,712, entitled ROLL-UP DOOR AND SYSTEM INCLUDING SAME, filed May 13, 2022, the disclosure of which is incorporated by reference herein in its entirety.

### BACKGROUND

This application discloses a roll-up door and a system including the roll-up door. A roll-up door typically includes a metal door which, once installed, is movable between a fully closed position and a fully open position. In the fully closed position, the roll-up door covers or fills an opening to secure the opening and has a bottom which generally is in contact with a floor or similar surface. When moving from the fully closed position to the fully open position, the roll-up door moves upward away from the floor and wraps itself into a coil directly above the opening. Roll-up doors are utilized in many applications, and such applications include, for example, self-storage facilities, shipping containers, garage doors, loading dock doors and other commercial applications. With respect to self-storage facilities and the individual storage units they include, it has been estimated there are over 20,000,000 individual storage units in the United States alone.

With so many roll-up doors in use, a lengthy track record has been established which recognizes issues associated with the roll-up doors which have been encountered more often than desired. For example, roll-up doors are typically shipped in the coiled configuration, with multiple coiled doors stacked in a pyramid or similar arrangement. Because the coiled doors are in metal-to-metal contact with one another and are generally strapped down to avoid movement during transit, it is all too common for multiple doors of a given shipment to arrive at a jobsite damaged, thereby causing the need to re-order more doors, delaying the completion of the project, and leading to added expenses and/or lost potential revenue.

The installation of known roll-up doors can also be relatively time consuming and thus relatively expensive. With some jobs involving hundreds of roll-up doors, with different sizes of doors, it is often necessary for an installer to first figure out which door goes where. Unfortunately, many roll-up doors are shipped in a manner which does not allow the installer to easily distinguish between different size doors and/or the specific size of a given door. Also, most of the hardware associated with the roll-up door (e.g., latch, rope, handle, stops, etc.) is typically shipped in a separate box and has to be installed at the jobsite. The individual boxes and/or the hardware therein are misplaced more often than desired, and the need to install multiple components at the jobsite takes a relatively significant amount of time. Additionally, once the roll-up door is positioned in the opening and the hardware has been installed, the roll-up door generally needs to be torsioned to make sure the door is balanced (the door doesn't creep upward or downward from a partially opened position). Typically, this process involves using a specialized tool to make a relatively large number of quarter turns, one at a time, until the door is sufficiently balanced. With known roll-up doors, the overall installation process can easily take 20 minutes or more per door.

Once a given roll-door up door has been installed and is in use, it is also common for the door to incur damage. Such damage can be incurred from a variety of different sources (e.g., a forklift or other piece of equipment, an individual closing a door onto an object positioned on the floor under the door, etc.). In some cases, the damage can be merely cosmetic and the roll-up door will still operate as intended. In other cases, as known roll-up doors are not configured to allow for the replacement of individual door panels or the bottom bar (e.g., individual door panels are not removable and the bottom bar is welded to the bottom door panel), the damage can be severe enough to necessitate the need to replace the entire roll-up door. When a damaged roll-up door needs to be replaced, costs associated with the replacement door and the labor to install the replacement door are incurred. In addition, the self-storage unit, shipping container, loading dock bay, etc. associated with the replacement door is rendered unavailable for use. Thus, there is also an opportunity cost incurred with the replacement of a damaged roll-up door.

### BRIEF DESCRIPTION OF THE DRAWINGS

FIG. 1 illustrates a roll-up door system in a closed position, in accordance with at least one aspect of the present disclosure;

FIG. 1A illustrates the roll-up door system of FIG. 1 in an open position, in accordance with at least one aspect of the present disclosure;

FIG. 2 illustrates a roll-up door of the roll-up door system of FIG. 1, in accordance with at least one aspect of the present disclosure;

FIG. 3 illustrates a removable aspect of a bottom bar of the roll-up door of FIG. 2, in accordance with at least one aspect of the present disclosure;

FIG. 4 illustrates a cross-sectional view of a door panel of the roll-up door of FIG. 2, in accordance with at least one aspect of the present disclosure;

FIG. 5 illustrates a cross-sectional view of two door panels of the roll-up door of FIG. 2 connected to one another, in accordance with at least one aspect of the present disclosure;

FIG. 6 illustrates an axle-drum assembly of the roll-up door system of FIG. 1, in accordance with at least one aspect of the present disclosure;

FIG. 7 illustrates the roll-up door of FIG. 2 connected to the axle-drum assembly of FIG. 6, in accordance with at least one aspect of the present disclosure;

FIG. 8 illustrates a tensioner assembly of the roll-up door system of FIG. 1, in accordance with at least one aspect of the present disclosure;

FIG. 9 illustrates an exploded view of the tensioner assembly of FIG. 8, in accordance with at least one aspect of the present disclosure;

FIG. 10 illustrates a first end of a tensioner cylinder of the tensioner assembly of FIG. 8, in accordance with at least one aspect of the present disclosure;

FIG. 11 illustrates a second end of the tensioner cylinder of FIG. 10 in accordance with at least one aspect of the present disclosure;

FIG. 12 illustrates a hood assembly of the roll-up door system of FIG. 1, in accordance with at least one aspect of the present disclosure;

FIG. 13 illustrates an exploded view of the hood assembly of FIG. 12, in accordance with at least one aspect of the present disclosure.

FIG. 14 is a front view of a first end panel of the hood assembly of FIG. 12, in accordance with at least one aspect of the present disclosure;

FIG. 15 is an isometric view of the first end panel of FIG. 14, in accordance with at least one aspect of the present disclosure;

FIG. 16 illustrates the first end panel of FIG. 14 with a bearing removably coupled thereto, in accordance with at least one aspect of the present disclosure;

FIG. 17 is a cross-sectional view of the first end panel of FIG. 16, in accordance with at least one aspect of the present disclosure;

FIG. 18 is a detailed view of the bearing of FIG. 16 removably coupled to the first end of panel of FIG. 16, in accordance with at least one aspect of the present disclosure;

FIG. 19 is a front view of a second end panel of the hood assembly of FIG. 12, in accordance with at least one aspect of the present disclosure;

FIG. 20 is an isometric view of the second end panel of FIG. 19, in accordance with at least one aspect of the present disclosure;

FIG. 21 is a detailed view of a support angle coupled to the first end panel of FIG. 12, in accordance with at least one aspect of the present disclosure;

FIG. 22 is a front view the support angle coupled to the first end panel of FIG. 21, in accordance with at least one aspect of the present disclosure;

FIG. 23 illustrates a grommet for use with the hood assembly of FIG. 12, in accordance with at least one aspect of the present disclosure; and

FIG. 24 illustrates an alternative hood assembly for use with a roll-up door system, in accordance with at least one aspect of the present disclosure.

### DESCRIPTION

In the following detailed description, reference is made to the accompanying drawings, which form a part hereof. In the drawings, similar symbols and reference characters typically identify similar components throughout several views, unless context dictates otherwise. The illustrative aspects described in the detailed description, drawings and claims are not meant to be limiting. Other aspects may be utilized, and other changes may be made, without departing from the scope of the technology described herein.

The following description of certain examples of the technology should not be used to limit its scope. Other examples, features, aspects, embodiments and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, aspects, embodiments, examples, etc. described herein may be combined with any one or more of the other teachings, expressions, aspects, embodiments, examples, etc. that are described herein. The following described teachings, expressions, aspects, embodiments, examples, etc. should therefore not be viewed in isolation relative to each other. Such modifications and variations are intended to be included within the scope of the claims.

Before explaining the various aspects of the roll-up door system in detail, it should be noted that the various aspects disclosed herein are not limited in their application or use to the details of construction and arrangement of parts illustrated in the accompanying drawings and description. Rather, the disclosed aspects may be positioned or incorporated in other aspects, variations and modifications thereof, and may be practiced or carried out in various ways. Accordingly, aspects of the roll-up door system disclosed herein are illustrative in nature and are not meant to limit the scope or application thereof. Furthermore, unless otherwise indicated, the terms and expressions employed herein have been chosen for the purpose of describing the aspects for the convenience of the reader and are not meant to limit the scope thereof. In addition, it should be understood that any one or more of the disclosed aspects, expressions of aspects, and/or examples thereof, can be combined with any one or more of the other disclosed aspects, expressions of aspects, and/or examples thereof, without limitation.

Also, in the following description, it is to be understood that terms such as outward, inward, upward, downward, above, below and the like are words of convenience and are not to be construed as limiting terms. Terminology used herein is not meant to be limiting insofar as devices described herein, or portions thereof, may be attached or utilized in other orientations. The various aspects will be described in more detail with reference to the drawings.

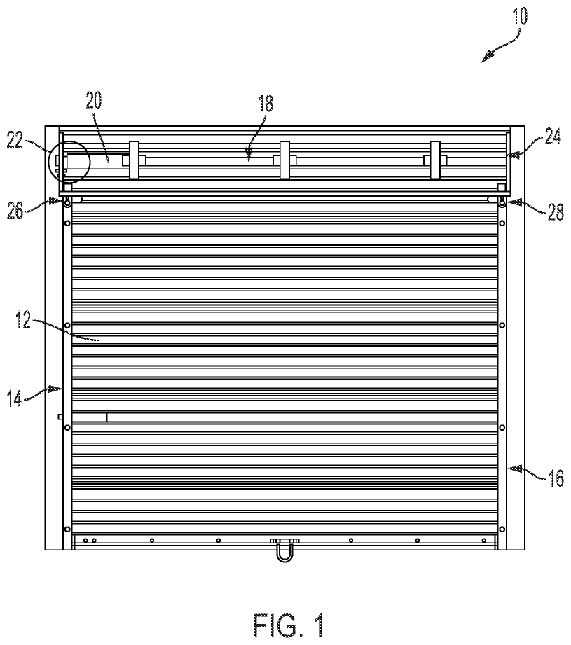

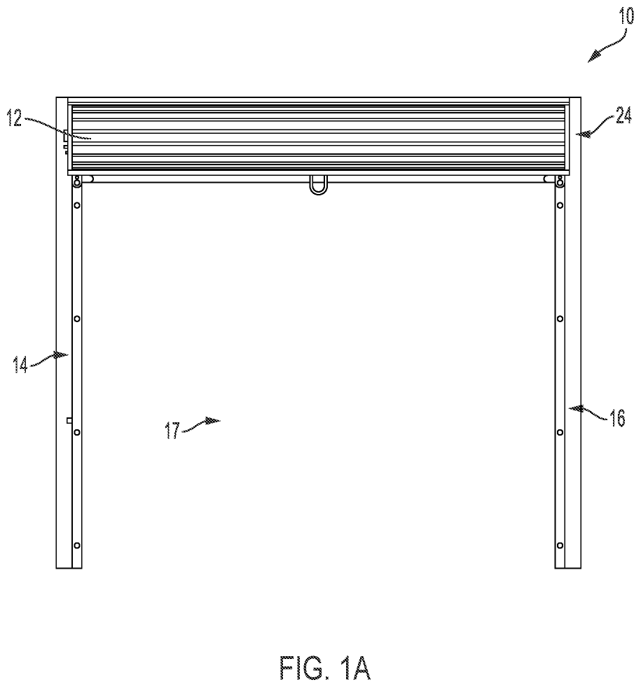

FIG. 1 illustrates a roll-up door system 10, in accordance with at least one aspect of the present disclosure. The roll-up door system 10 includes a roll-up door 12, first and second door guides 14, 16, an axle-drum assembly 18, a torsion spring 20, a tensioner assembly 22, a hood assembly 24, and first and second head stops 26, 28. The roll-up door system 10 may be utilized in any number of applications, such as, for example, self-storage facilities, shipping containers, residential and commercial garage doors, loading dock doors, security doors and commercial applications. However, for purposes of simplicity, the roll-up door system 10 will be described hereinafter in the context of its use in a self-storage facility.

The first and second door guides 14, 16 may be fabricated from any suitable material. For example, according to various aspects, the first and second door guides 14, 16 include polyvinyl chloride (PVC). According to other aspects, the first and second door guides 14, 16 include a metal such as a galvanized steel. According to other aspects, the first and second door guides 14, 16 include a high density polyethylene (HDPE)/low density polyethylene (LDPE) blend wear strip. The first and second door guides 14, 16 may be of any suitable configuration to allow the roll-up door 12 to roll or glide between the first and door guides 14, 16 as the roll-up door 12 moves between a fully closed, or deployed, position (See FIG. 1), in which the roll-up door 12 extends from the hood assembly 24 to cover or fill an opening 17, and a fully open, or stored position (See FIG. 1A), in which the roll-up door 12 is wound around the axle-drum assembly 18 within the hood assembly 24, exposing the opening 17.

A cross-section of the first door guide 14 may be generally U-shaped, for example, and a similar cross-section of the second door guide 16 may also be generally U-shaped, for example. Each of the first and second door guides 14, 16 may be considered to be configured to receive the roll-up door 12. The first and second door guides 14, 16 may be of any suitable height, are typically the same height, and generally are configured to extend from a floor or a similar surface to a point between a bottom surface and a top surface of the hood assembly 24. Although not shown for purposes of simplicity, the first and second door guides 14, 16 include openings at predetermined locations which are configured to receive fasteners to secure the first and second door guides 14, 16 to the hood assembly 24 and/or to the “left” and “right” sidewalls of an opening, respectively.

When the roll-up door 12 is in the deployed position, or state, the roll-up door 12 extends from the hood assembly 24 a distance so as to cover, or at least substantially cover, the opening 17 about which the roll-up door system 10 is installed. When the roll-up door 12 is in the stored position, or state, the roll-up door 12 is wound about the axle-drum assembly 18 such that none of the roll-up door 12 extends outside of the hood assembly 24 into the opening. Stated another way, in the stored stated, the roll-up door 12 is wound about the axle-drum assembly 18 such that the roll-up door 12 is encompassed by the frame of the hood assembly 24. However, various alternative embodiments are envisioned in which a portion of the roll-up door 12 extends out of the hood assembly 24 when the roll-up door 12 is in its stored position.

For a given opening in a building, the first door guide 14 may be positioned against the left side of the opening and secured to the building with suitable removable fasteners such as, for example, self-tapping screws, lag screws, sleeve anchors, etc. which can be countersunk into the first door guide 14. Similarly, the second door guide 16 may be positioned against the right side of the opening and secured to the building with suitable removable fasteners such as, for example, self-tapping screws, lag screws, sleeve anchors, etc. which can be countersunk into the second door guide 16. Thus, it will be appreciated the first and second door guides 14, 16 are removably secured to the building. The left side and the right side of the given opening in the building may be defined by concrete block, metal, wood, combinations thereof and the like.

The first head stop 26 is connected to the first door guide 14, and the second head stop 28 is connected to the second door guide 16. According to various aspects, the first and second head stops 26, 28 are shipped in a package with the first and second door guides 14, 16 and are subsequently connected to the first and second door guides 14, 16 at the jobsite. According to various aspects, the first and second head stops 26, 28 are shipped in a package separate from the first and second door guides 14, 16 and are subsequently connected to the first and second door guides 14, 16 at the jobsite. According to other aspects, the first and second head stops 26, 28 are connected to the first and second door guides 14, 16 prior to the shipment of the first and second door guides 14, 16 in a single package. Other embodiments are envisioned without headstops.

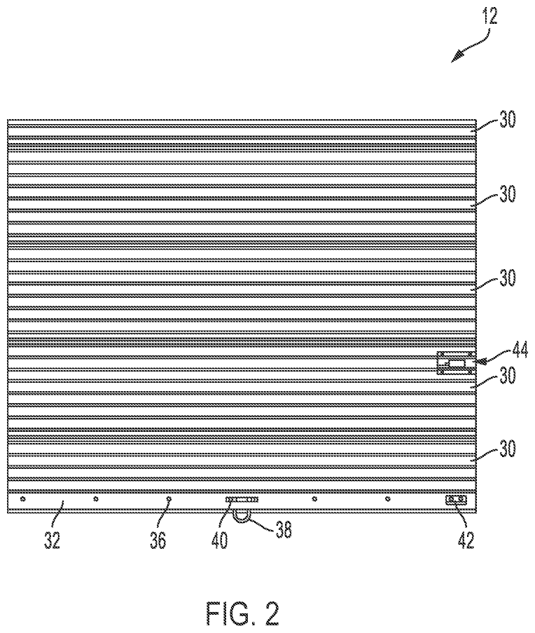

FIG. 2 illustrates the roll-up door 12, in accordance with at least one aspect of the present disclosure. The roll-up door 12 may be fabricated from any suitable material. For example, according to various aspects, the roll-up door 12 is comprised of a metal such as a galvanized steel. The roll-up door 12 is configured to roll or glide between the first and second door guides 14, 16 between a fully closed, or deployed, position (See FIG. 1) and a fully open, or stored, position (See FIG. 1A). For example, the roll-up door 12 may roll or glide between the first and second door guides 14, 16 in a downward direction toward the ground to close and in an upward direction from the ground to open. Stated differently, the roll-up door 12 is movable along a longitudinal/vertical length of the first door guide 14 and/or along a longitudinal/vertical length of the second door guide 16.

The roll-up door 12 includes a plurality of door panels 30. The door panels 30 may be of any suitable overall size. For example, for a given self-storage locker application, the roll-up door 12 comprises five door panels 30. In this example, the five door panels 30 are of equal width and equal height. As used in this example, the height of a door panel is measured with respect to a vertical dimension where the width of a door panel is measured with respect to a horizontal dimension that is orthogonal to the vertical dimension. That said, it should be understood that the door panels can be oriented in any suitable manner and the terms height and width are adaptable to that orientation.

Alternative embodiments are envisioned in which one or more panels of a roll-up door has a different height and/or width than the other panels of the roll-up door. In various embodiments, at least one of the door panels 30 has a different height than the other door panels 30. In various embodiments, the uppermost door panel 30 has a first height, the lowermost door panel 30 has a second height, and the three middle door panels have a third height, where the first, second, and third heights are different than one another. In at least one embodiment, the lowermost door panel 30 is shorter than the other door panels 30 of a roll-up door 12. By having at least three of the door panels 30 the same height, the use of standard height door panels 30 is facilitated for at least 60% (three out of five) of the door panels 30 utilized with the roll-up door 12 for a given self-storage locker application.

The roll-up door 12 also includes a bottom bar 32 positioned on an exterior side of the lowermost door panel 30 and a weight bar 34 (hidden from view in FIG. 2) positioned on an interior side of the lowermost door panel 30. In this example, the exterior side of the door is the side of the door facing away from the interior of the storage unit while the interior side of the door is the side of the door facing the interior of the storage unit. The bottom bar 32 and the weight bar 34 are removably connected to the lowermost door panel 30 by a plurality of fasteners 36 (e.g., nuts and bolts). As illustrated in FIG. 2, the roll-up door 12 further includes a pull rope 38 connected to the weight bar 34, a handle 40 removably connected to the bottom bar 32, a foot plate 42 removably connected to the bottom bar 32, and/or a latch 44 removably connected to one of the door panels 30. In various embodiments, the roll-up door 12 does not include the foot plate 42. In various embodiments, the pull rope 38, the handle 40, the foot plate 42, and/or latch 44 can be connected to and/or otherwise a part of any suitable component of a roll-up door. For instance, the handle 40 and the foot plate 42 can be directly connected to the lowermost door panel 30 of the roll-up door 12. In at least one embodiment, the handle 40 and the foot plate 42 are connected to the lowermost panel 30 through the bottom bar 32.

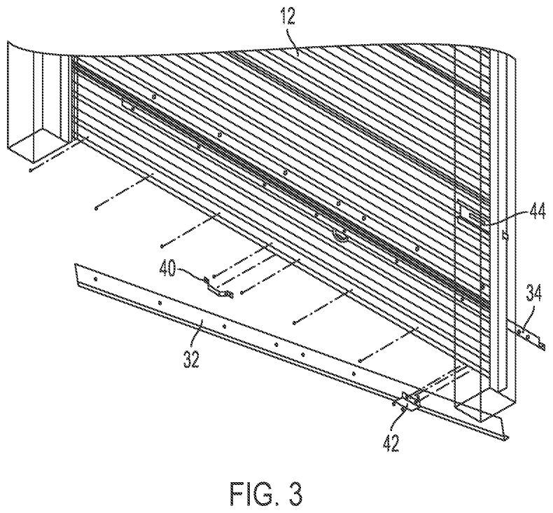

FIG. 3 illustrates a removable aspect of the bottom bar 32, in accordance with at least one aspect of the present disclosure. For purposes of simplicity, only a portion of the roll-up door 12 is shown in FIG. 3. If the bottom bar 32 becomes damaged and needs to be replaced, in various embodiments it can be replaced by simply removing the fasteners 36, replacing the damaged bottom bar 32 with another one, and reinstalling the fasteners 36-all without having to replace the lowermost door panel 30. In embodiments where the weight bar 34, the handle 40, and/or the foot plate 42 are attached to the lowermost door panel 30, the bottom bar 32 can be replaced without having to replace these components.

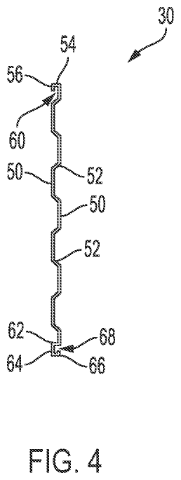

FIG. 4 illustrates a cross-sectional view of one of the door panels 30, in accordance with at least one aspect of the present disclosure. The door panel 30 includes a plurality of flat or planar portions 50 which are oriented plumb (vertical) to a floor when the roll-up door 12 is installed and the roll-up door 12 is in its deployed state. The uppermost and lowermost flat or planar portions 50 may have a different height than the other flat or planar portions 50. Each of the other flat or planar portions 50 can be the same height. The planar or flat portions 50 are connected to one another by portions 52 which are oriented at an angle relative to the planar or flat portions 50. In various embodiments, the portions 52 are oriented at an angle of 45 degrees relative to the planar or flat portions 50. In other embodiments, the portions 52 may be oriented at angle which is less than 45 degrees (e.g., 30 degrees) or more than 45 degrees (e.g. 60 degrees) relative to the planar or flat portions 50. In at least one embodiment, the portions 52 are oriented relative to the portions 50 at an angle between 30 degrees and 60 degrees, for example. The portions 52 operate to increase the overall strength and stiffness of the door panel 30.

The door panel 30 shown in FIG. 4 is representative of one of the middle door panels 30 of the roll-up door 12, and the top of the door panel 30 includes an arm 54 which extends horizontally inward from the uppermost flat or planar portion 50, and a leg 56 which extends vertically downward from the arm 54. Collectively, the uppermost flat or planar portion 50, the arm 54, and the leg 56 form a channel 60 which is utilized to connect the door panel 30 to another of the door panels 30 of the roll-up door 12. In various embodiments, the channel 60 of the door panel 30 is also configured to be attached to the axle-drum assembly 18; however, various embodiments are envisioned in which the top of the uppermost door panel 30 of the roll-up door 12 has a different configuration that is connectable to the axle-drum assembly 18. The bottom of the door panel 30 shown in FIG. 4 includes an arm 62 which extends horizontally inward from the lowermost flat or planar portion 50, a first leg 64 which extends vertically downward from the arm 62, and a second leg 66 which extends horizontally outward then vertically upward from the first leg 64 such that a horizontal gap 68 is formed between the first leg 64 and the second leg 66. Collectively, the lowermost flat or planar portion 50, the arm 62, the first leg 64, and the second leg 66 form a channel 68 which is utilized to connect the door panel 30 to another of the door panels 30 of the roll-up door 12. In various embodiments, the channel 60 of the door panel 30 is also configured to the bottom bar 32 and/or the weight bar 34; however, various embodiments are envisioned in which the bottom of the lowermost door panel 30 of a roll-up door 12 has a different configuration that is connectable to the bottom bar 32 and/or weight bar 34.

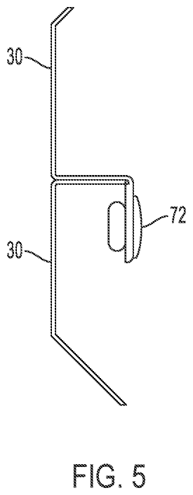

FIG. 5 illustrates a cross-sectional view of two door panels 30 of the roll-up door 12 connected to one another, in accordance with at least one aspect of the present disclosure. For purposes of clarity, only a top portion of one of the door panels 30 and a bottom portion of the other one of the door panels 30 are shown in FIG. 5. The two door panels 30 shown in FIG. 5 are representative of two of the middle door panels 30 of the roll-up door 12. According to various aspects, the channel 68 at the bottom of one of the door panels 30 is configured to slide in a horizontal direction into the channel 60 at the top of the other one of the door panels 30, and the friction fit of the two channels 60, 68 forms a seam 70. The respective seams 70 formed between adjacent door panels 30 of the roll-up door 12 are also shown, for example, in FIG. 7. For such aspects, the channel 60 may be considered as being configured to receive the channel 68. According to other aspects, the channel 60 at the top of one of the door panels 30 is configured to slide in a horizontal direction into the channel 68 at the bottom of the other one of the door panels 30, and the friction fit of the two channels 60, 68 forms a seam 70. For such aspects, the channel 68 may be considered as being configured to receive the channel 60. Once the seam 70 has been formed and the left and right sides of the two door panels 30 are horizontally aligned, two rivets 72 (only one is shown in FIG. 5) may be installed through the first leg 64, the leg 56 and the second leg 66 proximate the left side and the right side of the two door panels 30 to secure the two door panels 30 to one another. The combination of the friction fit of the two channels 60, 68 and the two rivets 72 provides sufficient strength and rigidity to the connection between the two door panels 30. That said, any suitable interconnection between adjacent door panels 30 can be used.

If one of the two door panels 30 becomes damaged during use of the roll-up door 12, the two rivets 72 can be easily removed (e.g., drilled out) and the two door panels 30 can be slid apart horizontally. The replacement door panel can then be slid horizontally into the proper position, and two new rivets 72 can be installed as described above. Thus, it will be appreciated that the door panels 30 are removable and a given door panel 30 can be easily replaced without the need to replace the entire roll-up door 12.

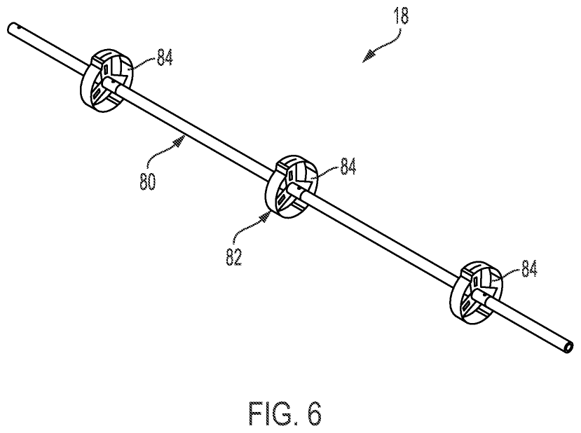

FIG. 6 illustrates the axle-drum assembly 18, in accordance with at least one aspect of the present disclosure. The axle-drum assembly 18 includes an axle or shaft 80 and a plurality of mini drums 82 mounted to the shaft 80 such that the mini drums 82 rotate with the shaft 80. The axle or shaft 80 may be fabricated from any suitable material. For example, according to various aspects, the axle or shaft 80 is fabricated from a galvanized steel pipe. The mini drums 82 may be fabricated from any suitable material. According to various aspects, the each of the mini drums 82 includes a metal such as, for example, a steel. Each mini drum 82 includes a collar 84 which is configured to allow the axle or shaft 80 to pass therethrough. The respective collars 84 may be secured to the axle or shaft 80 by threaded fasteners such as, for example, strip-resistant steel drilling screws. Each mini drum 82 is also configured to have the top of the uppermost door panel 30 attached thereto by fasteners (e.g., self-tapping screws) in a manner which allows the axle-drum assembly 18 to rotate as the roll-up door 12 is moved toward a fully open position and wraps itself into a coil which surrounds the axle-drum assembly 18. Although three mini drums 82 are shown in FIG. 6, the axle-drum assembly 18 may include less than three mini drums 82 (e.g., two) or more than (e.g., four) three mini drums 82.

Referring to FIG. 1, the torsion spring 20 surrounds one end of the shaft 80 of the axle-drum assembly 18. The torsion spring 20 defines an inner diameter and the shaft 80 extends through the inner diameter. The torsion spring 20 is positioned intermediate the tensioner assembly 22 and one of the mini drums 82, but could be positioned in any suitable location. The torsion spring 20 is sized and configured such that it is entirely positioned within the hood assembly 24. The torsion spring 20 has one end attached to the axle-drum assembly 18 and one end attached to the tensioner assembly 22, as discussed further below. Depending on the overall size of the roll-up door 12, the roll-up door 12 may be too heavy for a given person to lift upwardly by themselves and/or too heavy for a given person to control the descent of the roll-up door 12 to keep it from crashing down. The torsion spring 20 is configured to assist a person in moving the roll-up door 12 from the fully closed position toward the fully opened position, as well as assist in moving the roll-up door 12 from the fully opened position toward the fully closed position, thereby allowing a single person to sufficiently control the opening and closing of the roll-up door 12.

Further to the above, the door panels 30 of the roll-up door 12 are sufficiently flexible such that the roll-up door 12 can resiliently bend and wind around the axle-drum assembly 18 when the roll-up door 12 is moved from the fully closed position (FIG. 1) to the fully open position (FIG. 1A). As the roll-up door 12 is moved toward the fully open position, the roll-up door 12wraps into a coil that surrounds the axle-drum assembly 18 where more and more of the roll-up door 12 becomes positioned within the hood assembly 24 as the roll-up door 12 is moved into the fully open position. Correspondingly, the roll-up door 12 is unwrapped from the coil as the roll-up door 12 is moved toward a fully closed position where less and less of the roll-up door 12 is positioned within the hood assembly 24 as the roll-up door 12 is moved into the fully closed position. When the roll-up door 12 is in the fully closed position, referring to FIG. 7, four of the five door panels 30 are in a plumb or vertical configuration and orientation whereas the uppermost panel 30 of the roll-up door 12 is in a curved configuration which matches a curved path established by the door guides 14 and 16. That said, embodiments are envisioned where all of the door panels 30 of a roll-up door 12 are in a plumb or vertical configuration and orientation when the roll-up door 12 is in the fully closed position. Other embodiments are envisioned where more than one door panel 30 of a roll-up door 12 are in a curved configuration when the roll-up door 12 is in the fully closed position.

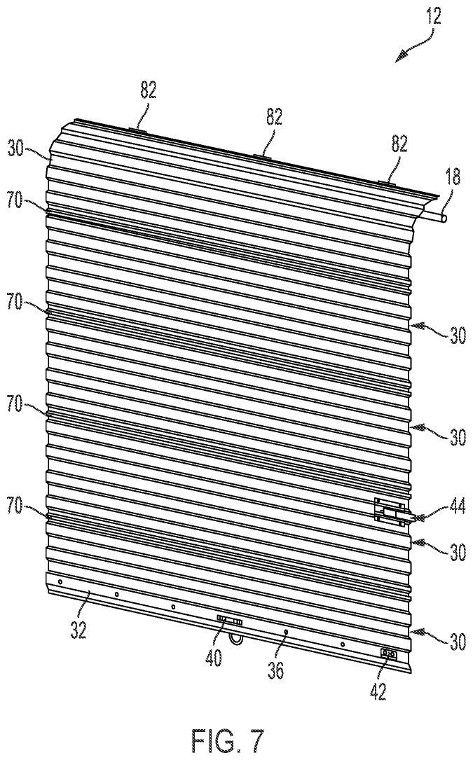

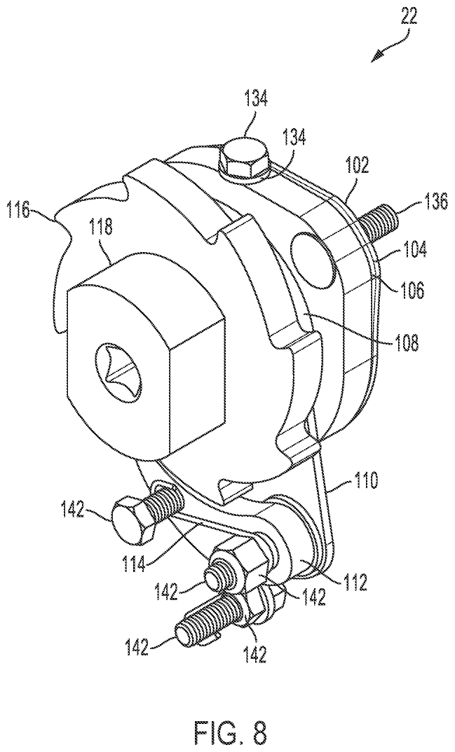

FIG. 8 illustrates the tensioner assembly 22, in accordance with at least one aspect of the present disclosure. The tensioner assembly 22 is connected to the torsion spring 20, the axle or shaft 80, and the hood assembly 24, is positioned (at least partially) within the hood assembly 24, and is configured to set the proper amount of tension on the torsion spring 20 in order to balance the roll-up door 12. When the roll-up door 12 is properly balanced, a given person can sufficiently control the opening and closing of the roll-up door 12, and the roll-up door 12 doesn't creep upward or downward from a partially opened position. According to various aspects, the tensioner assembly 22 includes a bearing 100, two bearing flanges 102, 104, a spring plate 106, a tensioner spacer 108, a tensioner stiffener 110, a pawl 112, a tensioner spring 114, a ratchet plate 116, and a tensioner cylinder 118.

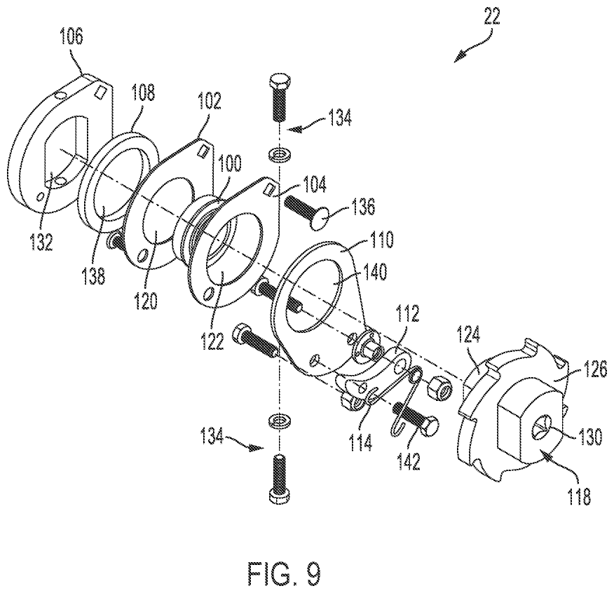

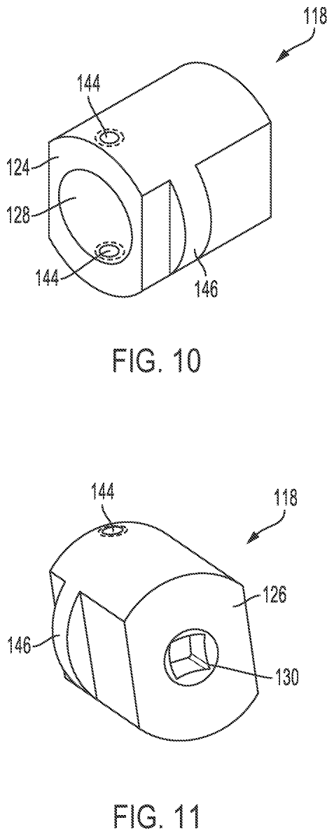

FIG. 9 illustrates an exploded view of the tensioner assembly 22, in accordance with at least one aspect of the present disclosure. The bearing 100 is positioned within the hood assembly 24 and is configured to receive an end of the shaft 80. The first and second bearing flanges 102, 104 are positioned within the hood assembly 24, and define respective openings 120, 122 which are configured to receive the bearing 100. Thus, the first and second bearing flanges 102, 104 surround the axle or shaft 80 and the bearing 100. The tensioner cylinder 118 includes a first end 124 positioned within the hood assembly 24 and a second end 126 positioned external to the hood assembly 24. The first end 124 of the tensioner cylinder 118 defines an opening 128 (See FIG. 10) which is configured to receive the bearing 100. Thus, the first end 124 of the tensioner cylinder 118 surrounds the axle or shaft 80 and the bearing 100. The second end 126 of the tensioner cylinder 118 defines an opening 130 configured to receive a square drive of a ratchet wrench to make an adjustment to the tension being applied by the tensioner assembly 22. When the square drive of the ratchet wrench is positioned into the opening 130 of the tensioner cylinder 118, for instance, a handle of the ratchet wrench may be rotated in a first direction to increase the tension being applied to the torsion spring 20, or in a second direction to decrease the tension being applied to the torsion spring 20. It will be appreciated that according to various aspects, the tension on the tensioner spring 114 is released prior to decreasing the tension being applied to the torsion spring 20.

In most applications, the proper tension can be set by simply moving the handle of the ratchet wrench around a longitudinal axis of the axle or shaft 80 in order to move the ratchet plate 116 one or two clicks in the first direction or one or two clicks in the second direction. By utilizing the tensioner assembly 22 to balance the roll-up door 12, the entire balancing process can, in many instances, be completed in approximately 30 seconds, a significant time savings when compared to the three to four minutes it takes to balance know roll-up doors (using a specialized tool to make a relatively large number of quarter turns, one at a time, until the door is sufficiently balanced). On jobs with a large number of roll-up doors 12, the time savings realized with the tensioner assembly 22 adds up to a considerable amount of time. As time is money, the time savings realized with the tensioner assembly 22 also adds up to a considerable savings in the labor cost associated with balancing the roll-up doors 12.

The spring plate 106 is positioned within the hood assembly 24, and defines an opening 132 configured to receive the first end 124 of the tensioner cylinder 118. The spring plate 106 is connected to the tensioner cylinder 118 via two fasteners 134 (e.g., stainless hex head bolts and stainless lock washers) which also operate as set screws to fix the position of the bearing 100 relative to the tensioner cylinder 118. The spring plate 106 is also connected to first and second bearing flanges 102, 104 via at least one fastener 136 (e.g., stainless steel carriage bolt). Thus, the spring plate 106 surrounds the axle or shaft 80, the bearing 100 and the first end 124 of the tensioner cylinder 118. The tensioner spacer 108 is positioned within the hood assembly 24, defines an opening 138 configured to allow the first end 124 of the tensioner cylinder 118 to pass therethrough, and is positioned or sandwiched between the spring plate 106 and an interior surface of the hood assembly 24. Thus, the tensioner spacer 108 surrounds the first end 124 of the tensioner cylinder 118.

The tensioner stiffener 110 is positioned external to the hood assembly 24, defines an opening 140 configured to allow the first end 124 of the tensioner cylinder 118 to pass therethrough, and is positioned or sandwiched between an exterior surface of the hood assembly 24 and the ratchet plate 116. Thus, the tensioner stiffener 110 surrounds the first end 124 of the tensioner cylinder 118. The pawl 112 is positioned external to the hood assembly 24, and is connected to tensioner stiffener 110 and the hood assembly 24 via two fasteners 142 (e.g., a stainless steel hex head screw and a nylon insert lock nut, and/or a stainless hex head bolt). The torsion spring 114, is positioned external to the hood assembly 24, and when set in a first position (e.g., hooked around one of the fasteners 142), is configured to prevent the ratchet plate 116 from rotating in a direction associated with decreasing the tension applied to the torsion spring 20. Of course, by removing the appropriate fastener, the torsion spring 114 can be moved to a second position to allow for the ratchet plate 116 to rotate in the direction associated with decreasing the tension applied to the torsion spring 20.

The ratchet plate 116 is positioned external to the hood assembly 24, and defines an opening (hidden from view) which allows for the second end 126 of the tensioner cylinder 118 to pass therethrough. The ratchet plate 116 surrounds the second end 126 of the tensioner cylinder 118, and may be welded or otherwise connected to/secured to/affixed to the tensioner cylinder 118. The tensioner cylinder 118 is further described hereinbelow with respect to FIGS. 10 and 11.

FIG. 10 illustrates the first end 124 of the tensioner cylinder 118 (the end positioned within the hood assembly 24), in accordance with at least one aspect of the present disclosure. As shown in FIG. 10, the tensioner assembly 118 defines the opening 128 configured to receive the bearing 100, and also defines two openings 144 which are configure to receive the two fasteners 134 which also operate as set screws to fix the position of the bearing 100 relative to the tensioner cylinder 118. The tensioner assembly 118 also defines a curved flange 146 which is configured to be received by and set in the opening 138 defined by the tensioner spacer 108.

FIG. 11 illustrates the second end 126 of the tensioner cylinder 118 (the end positioned exterior to the hood assembly 24), in accordance with at least one aspect of the present disclosure. As shown in FIG. 11, the tensioner assembly 118 defines the opening 130 configured to receive a square drive of a ratchet wrench.

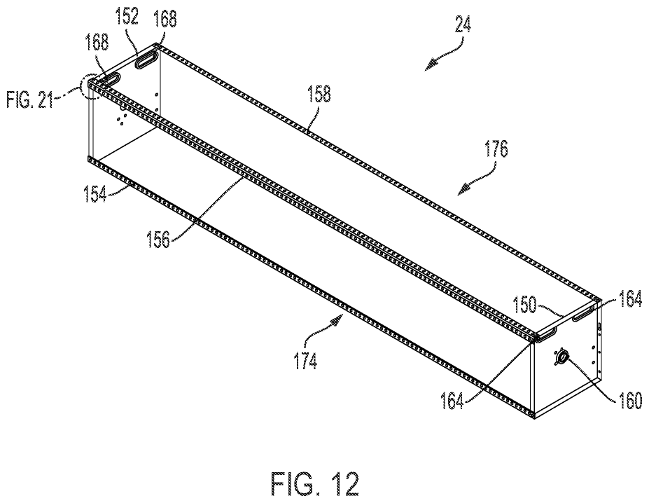

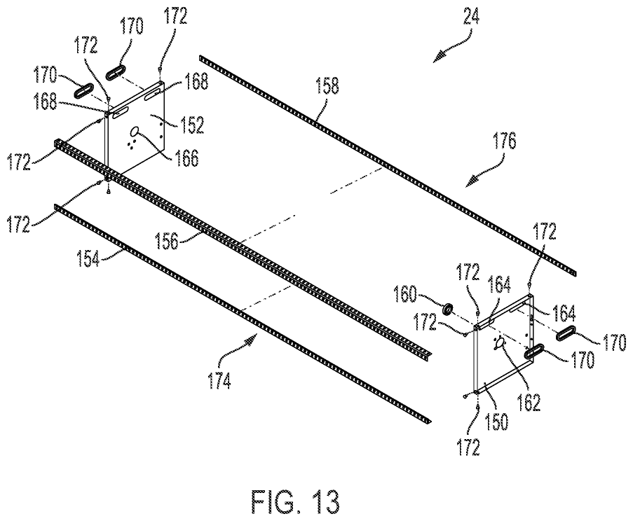

FIG. 12 illustrates the hood assembly 24, in accordance with at least one aspect of the present disclosure. FIG. 13 illustrates an exploded view of the hood assembly 24, in accordance with at least one aspect of the present disclosure. The hood assembly 24 includes a first end panel 150, a second end panel 152, and first, second and third support angles 154, 156, 158 which connect, or couple, the first end panel 150 to the second end panel 152. In various other embodiments, a hood assembly can comprise any suitable number of support angles and/or can comprise rods in lieu of the support angles, for example. The support angles 154, 156, and 158 each comprise an L-shaped cross-section but can comprise any suitable cross-section. The support angles 154, 156, and 158 comprise an array of apertures defined therein which can, among other things, be used as attachment points to a surrounding structure and/or reduce the weight of the hood assembly 24. The first end panel 150, the second end panel 152, and the support angles 154, 156, and 158 comprise a hood frame. The hood frame comprises a generally rectangular shape having a height and a depth that are the same, or are at least substantially the same, and an elongate width. That said, the hood frame can comprise any suitable shape. The first and second end panels 150 and 152 can be welded to the opposite ends of the support angles 154, 156, and 158 but can be attached to the first and second end panels 150 and 152 in any suitable manner, such as with fasteners, for example, which is discussed in greater detail below.

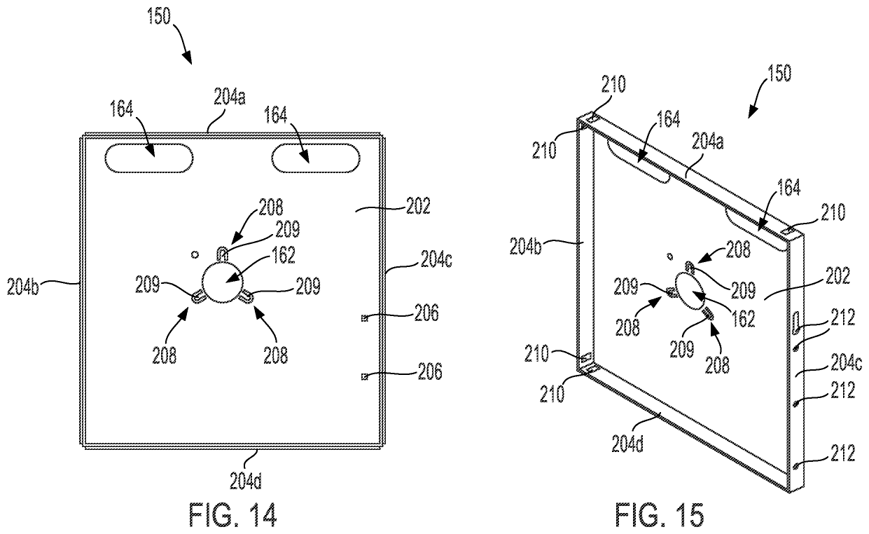

Referring now to FIGS. 14-18, the first end panel 150 can be of any suitable size and shape (e.g., square-shaped, rectangular-shaped), and can be fabricated from any suitable material (e.g., a metal such as a galvanized steel). In one aspect, the first end panel 150 is fabricated from a single sheet of metal (stamped, laser cut, etc.) and portions thereof are bent to form the first end panel 150. For instance, in one embodiment, referring to FIGS. 14 and 15, the first end panel 150 includes a body portion 202 and a plurality of folded portions 204a, 204b, 204c, 204d folded relative to the body portion 202. The body portion 202 defines first mounting holes 206 that are positioned to align with openings defined in the second door guide 16, described elsewhere herein. The first mounting holes 206 are sized to receive fasteners (bolts, screws, rivets, etc.) therethrough for mounting the first end panel 150 to the second door guide 16. The body portion 202 further defines a circular shaped opening 162 and a plurality of “U” shaped openings 208 circumferentially surrounding the circular shaped opening 162. Each of the “U” shaped openings 208 defines a tab 209, which will be discussed in more detail below.

The folded portions 204a, 204b, 204d of the first end panel 150 define second mounting holes 210 that are sized to receive fasteners, such as bolts, screws, rivets, etc., for mounting the first, second, and third support angles 154, 156, 158 to the first end panel 150, as will be described in more detail below. In addition, the folded portion 204c of the first end panel 150 defines third mounting holes 212 that are sized to receive fasteners, such as self-tapping screws, lag screws, sleeve anchors, etc., for mounting the first end panel 150 to a “right” sidewall of an opening, such as opening 17.

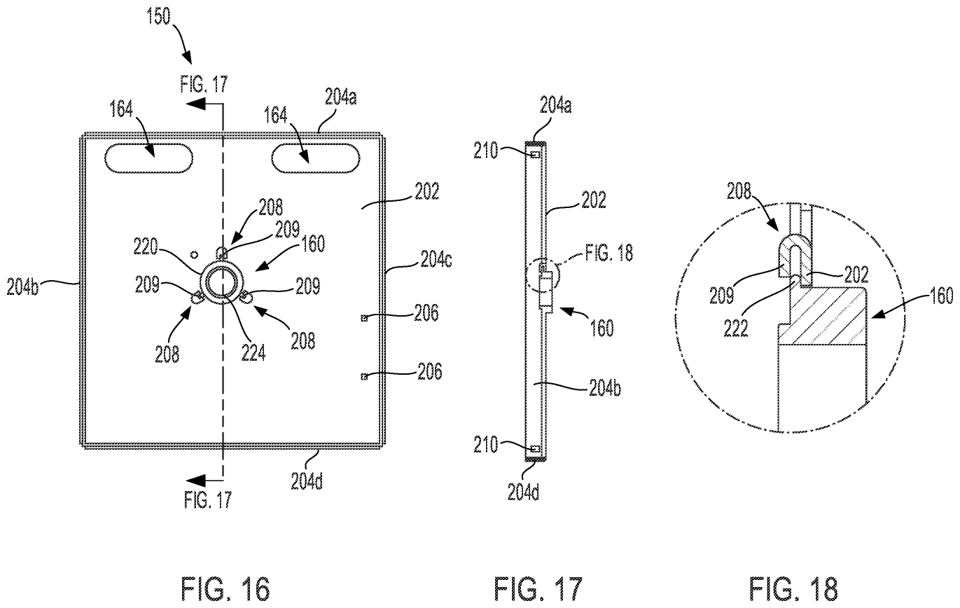

The hood assembly 24 also includes a bearing 160 which sets in the circular-shaped opening 162 (See FIG. 13) defined by the first end panel 150. Referring primarily to FIGS. 16-18, the bearing 160 comprises an outer ring 220 that includes a lip 222 and an inner ring 224 that is rotatable relative to the outer ring 220. To mount the bearing 160 in the opening 162 of the first end panel 150, the bearing 160 is inserted through the opening 162 until the lip 222 of the outer ring 220 engages the body portion 202 (See FIG. 18). Once positioned in the opening 162, the tabs 209 defined by the U-shaped openings 208 are folded relative to the body portion 202 until the free ends of the tabs 209 engage the lip 222, thus removably coupling the bearing 160 to the first end panel 150 within the opening 162. While three “U′ shaped openings 208 are shown in the Figures, it should be understood that more or less “U” shaped openings can be defined in the body portion 202 for removably coupling the bearing 160 within the opening 162. In an instance where the bearing is damaged or needs to be replaced, the tabs 209 are bent away from the lip 222 to release the bearing 160 and a new bearing can be installed within the opening 162.

The inner ring 224 of the bearing 160 is configured to receive and support an end of the shaft 80 (the end opposite the tensioner assembly 22). The inner ring 224 defines an aperture which is configured to closely receive the end of the shaft 80. In at least one instance, a friction fit exists between the end of the shaft 80 and the sidewalls of the inner ring aperture such that the inner ring 224 and the shaft 80 rotate together. In at least one embodiment, a set screw can be used to connect the inner ring 224 to the shaft 80. In various other embodiments, a bearing can be used in lieu of bearing 160 which does not comprise a movable inner ring. In at least one such embodiment, the bearing comprises an aperture that closely receives the end of the shaft 80 but permits the shaft 80 to rotate relative to the bearing. The body portion 202 of the first end panel 150 also defines two oval-shaped openings 164 which can be utilized to lift, carry and/or other move the hood assembly 24 from one location/position to another location/position.

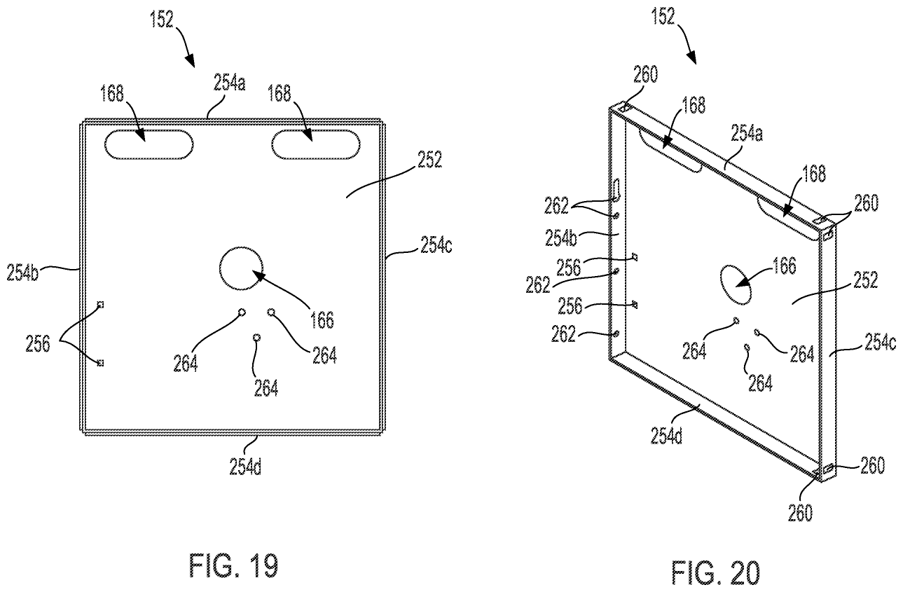

Referring now to FIGS. 19 and 20, the second end panel 152 can be of any suitable size and shape (e.g., square-shaped, rectangular-shaped), and can be fabricated from any suitable material (e.g., a metal such as a galvanized steel). The second end panel 152 is fabricated from a single sheet of metal (stamped, laser cut, etc.) and portions thereof are bent to form the second end panel 152. In at least one embodiment, the second end panel 152 includes a body portion 252 and a plurality of folded portions 254a, 254b, 254c, 254d folded relative to the body portion 252. The body portion 252 defines first mounting holes 256 that are positioned to align with openings in the first door guide 1, described elsewhere herein. The first mounting holes 256 are sized to receive fasteners (bolts, screws, rivets, etc.) therethrough for mounting the second end panel 152 to the first door guide 14. The body portion 252 of the second end panel 152 further defines a circular-shaped opening 166 (See FIG. 13) configured to allow the curved flange 146 of the tensioner cylinder 118 to pass therethrough and/or set therein. The body portion 252 of the second end panel 152 also defines two oval-shaped openings 168 which can be utilized to lift, carry and/or other move the hood assembly 24 from one location/position to another location/position.

The folded portions 254a, 254c, 254d of the second end panel 152 define second mounting holes 260 that are sized to receive fasteners, such as bolts, screws, rivets, etc., for mounting the first, second, and third support angles 154, 156, 158 to the second end panel 152, as will be described in more detail below. In addition, the folded portion 254b of the second end panel 152 defines third mounting holes 262 that are sized to receive fasteners, such as self-tapping screws, lag screws, sleeve anchors, etc., for mounting the second end panel 152 to a “left” sidewall of an opening, such as opening 17.

The body portion 252 further defines third mounting holes 264 that are sized to receive the fasteners 142 therethrough for mounting the tensioner assembly 22 to the second end panel 152.

According to various aspects, the hood assembly 24 further includes four grommets 170 (See FIGS. 13 and 23) which are removably positioned within the oval-shaped openings 164, 166 of the first end panel 150 and the second end panel 152. Each grommet 170 comprises a body 270 and a track 272 defined around the perimeter thereof. The track 272 is sized to removably receive the edges of the opening 164, 166 when the grommets 170 are positioned therein. The grommets 170 may be fabricated from any suitable material (e.g., a rubber) and are utilized to protect workers from cuts, scrapes, injuries which can be caused by the workers coming into contact with a sharp metal edge when carrying and/or otherwise handling the roll-up door system 10. In various embodiments, the hood assembly 24 does not include grommets 170.

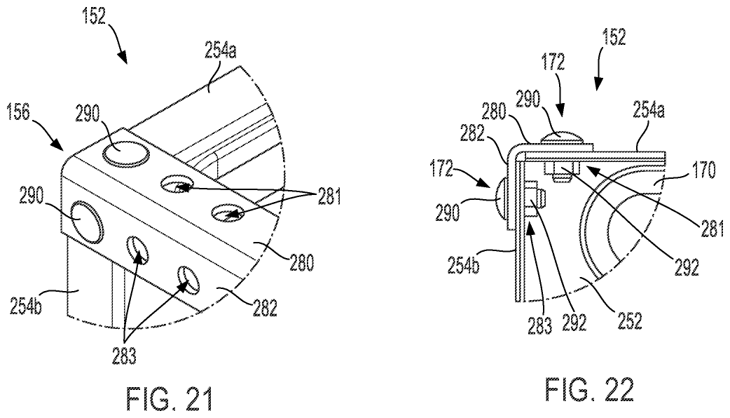

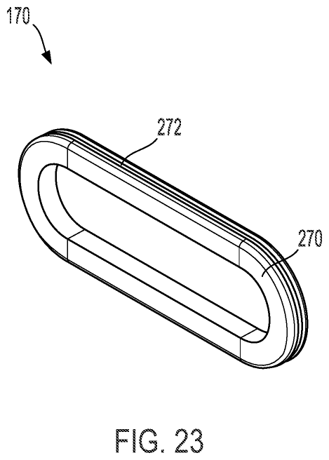

The first, second and third support angles 154, 156, 158 are connected to both the first end panel 150 and the second end panel 152 via a plurality of fasteners 172 (See FIGS. 13, 21, and 22). In various instances, the first, second and third support angles 154, 156, 158 comprise L-shaped angle iron that includes a first bar 280 and second bar 282 angled relative to the first bar 280. The first bar 280 defines a first plurality of apertures 281 along the length thereof and the second bar 282 defines a second plurality of apertures 283 along the length thereof. The fasteners 172 may be any suitable type of fasteners. For example, according to various aspects, the fasteners 172 are pop-rivets. In various other aspects, the fasteners 172 comprise bolts 290 that extend through the end-most apertures 281, 283 in the first bar 280 and the second bar 282, respectively, and through a corresponding second mounting hole 210, 260 defined in the first end panel 150 or second end panel 152. For example, as shown in FIGS. 21 and 22, the second support angle 156 is situated against the second end panel 152 such that the end-most aperture 281 on the first bar 280 aligns with the second mounting hole 260 in the folded portion 254a. Similarly, the end-most aperture 283 of the second bar 282 is aligned with the second mounting 260 in the folded portion 254b. A bolt is inserted through each of the aligned apertures and a nut 292 is threadably coupled to each bolt 290 to secure the second support angle 156 to the second end panel 152. It should be understood that a similar procedure is performed for mounting each of the support angles 154, 156, 158 to the first end panel 150 and the second end panel 152 to define the frame of the hood assembly 24. In various other embodiments, rather than having a plurality of apertures 281, 283, the support angles 154, 156, 158 only have apertures that align with the corresponding second mounting hole 210, 260 defined in the first end panel 150 or second end panel 152, this providing additional structure support to the support angles 154, 156, 158.

As shown in FIG. 12, based on the positioning of the second mounting holes 210, 260, the first and second support angles 154, 156 are connected to a first side 174 of the hood assembly 24, and the third support angle 158 is connected to a second side 176 of the hood assembly 24. According to various aspects, the first side 174 is the side facing the interior of the self-storage locker and the second side 176 is the side facing the exterior of the self-storage locker. According to other aspects, the first side 174 is the side facing the exterior of the self-storage locker and the second side 176 is the side facing the interior of the self-storage locker.

With the first, second and third support angles 154, 156, 158 being connected to the first and second end panels 150, 152, the hood assembly 24 is sufficiently rigid to withstand the rigors of shipping and in contrast to known roll-up doors, provide increased protection to the roll-up door 12 during shipping and subsequent movement around the jobsite. Additionally, with the openness of the hood assembly 24, the overall weight of the hood assembly 24 is very reasonable, thereby allowing for easier handling of the hood assembly 24 during shipping and at the jobsite.

When the roll-up door system 10 is shipped, in various instances, there are only two packages associated with each roll-up door system 10. One package includes the two door guides 14, 16, and the first and second head stops 26, 28. As described above, the first and second head stops 26, 28 may or may not be be connected to the first and second door guides prior to shipping or at the jobsite. Various other embodiments are envisioned in which the two door guides 14, 16 are shipped in one package and the first and second head stops 26, 28 are shipped in a separate package and installed to the door guides 14, 16 at the job site. All of the other components of the roll-up door system 10 are preassembled and included in a second package associated with the hood assembly 24. The hood assembly 24 is fully assembled, and within the hood assembly package, the axle-drum assembly 18 is already installed, the torsion spring 20 is already installed, the tensioner assembly 22 is already installed, and the roll-up door 12 is already connected to the axle-drum assembly 18 and wrapped up in a coil, in the stored state, within the hood assembly 24. By including so much in one package (the hood assembly package), less items are lost or misplaced prior to shipping (at the factory), during shipping and on the jobsite, resulting in less administrative time, less delays, and quicker completion of the job. Also, having the components within the hood assembly package preassembled/already installed, the jobsite assembly of the roll-up door system 10 is much faster than the time associated with known roll-up doors.

Once the two packages of the roll-up door system 10 arrive at a jobsite, the installation of the roll-up door system 10 is relatively straightforward. First, the door guides 14, 16 and the hood assembly 24 are set down on the floor proximate the opening of the self-storage locker, and the door guides 14, 16 are connected to the hood assembly 24 (via first mounting holes 206, 256) with appropriate fasteners (e,g,. ribbed elevator bolts and stainless steel nylon flange locknuts or carriage bolts and KEPS Nuts). The resulting assembly is then walked/rotated upward until the hood assembly 24 is proximate the top of the opening of the self-storage locker. Once the resulting assembly is properly positioned within the opening, the door guides 14, 16 are secured to the left side wall and the right side wall of the opening with appropriate fasteners. In addition, the hood assembly 24 is secured to the left side wall with appropriate fasteners through the third mounting holes 262 of the second end panel 152 and the right side wall with appropriate fasteners through the third mounting holes 212 in the first end panel 150. According to various aspects, the first and second head stops 26, 28 may also need to be secured to the door guides 14, 16. In various instances, the first head stop 26 is assembled to the first door guide 14 and the second head stop 28 is assembled to the second door guide 16 such that the head stops 26 and 28 can limit the upward travel of the door within the door guides 14 and 16. In such instances, the roll-up door 12 is prevented from being entirely wound up within the hood assembly 24. That said, instances are envisioned in which it may be desirable for the entire roll-up door 12 to be wound up within the hood assembly 24 when the roll-up door 12 is moved into its fully-open state. In at least one such instance, the head stops 26 and 28 are not installed. In any event, the bottom bar 32 and the weight bar 34 can be withdrawn into the hood assembly 24 when the roll-up door 12 is moved into its fully-open state.

For instances where renovation work is being performed, the hood assembly 24 may first be installed to the left side wall and the right side wall of the opening. The door guides 14, 16, which are adjustable, may thereafter be installed. Various other embodiments are envisioned in which the door guides 14, 16 are not adjustable.

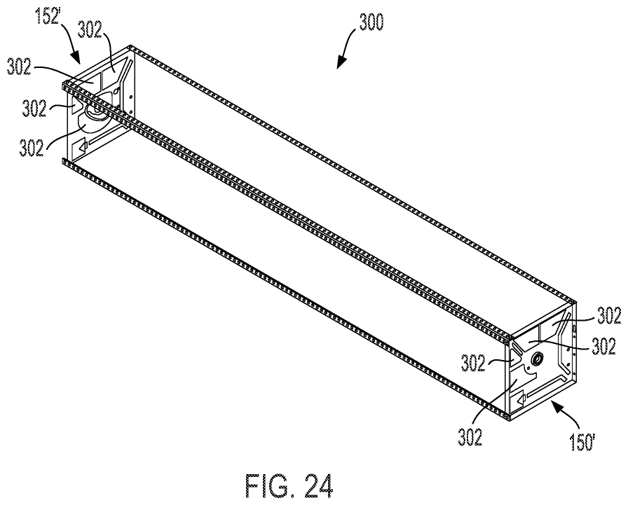

Referring now to FIG. 24, an alternative hood assembly 300 is provided, in accordance with at least one aspect of the present disclosure. The hood assembly 300 can be used in lieu of the hood assembly 24 in the roll-up door system 10. The hood assembly 300 is substantially similar to the hood assembly 24 except for some of the differences noted herein. Similar to hood assembly 24, the hood assembly 300 includes a first end panel 150′ and a second end panel 152′, which are similar to the first end panel 150 and the second end panel 152, respectively. The first end panel 150′ and second end panel 152′ define a plurality of apertures therein which function to diminish the weight of the first and second end panels 150′, 152′ without compromising the first and second end panels 150′, 152′ ability to support the axle-drive assembly 18 and roll-up door 30 in the roll-up door system 10.

Further to the above, the roll-up door system 10 is deliverable to a job site, for instance, in an undeployed state. In this undeployed state, the roll-up door 12 is entirely wound up within the frame of the hood assembly 24 such that the roll-up door 12 does not extend outside of the frame. In various instances, the hood assembly frame defines a rectangular volume and the roll-up door 12 is contained in the rectangular volume when the roll-up door 12 is in its undeployed state. With regard to the roll-up door system 10, the first end panel 150 and the second end panel 152 define the rectangular volume and, when the roll-up door 12 is entirely positioned within the rectangular volume, it can be said that the roll-up door 12 is entirely positioned within the hood assembly frame. In such instances, the possibility of the roll-up door 12 becoming damaged during shipping, for instance, is reduced. In various embodiments, the bottom bar 32 and the weight bar 34 are also entirely contained within the frame of the hood assembly 24 when the roll-up door system 10 is in its undeployed state. In some instances, it is possible, though, the bottom bar 32, the weight bar 34, and/or a portion of the roll-up door 12 may extend outside of the frame of the hood assembly 24 when the roll-up door system 10 is in its undeployed state. In any event, several roll-up door systems 10 can be shipped together on a pallet. Owing to their rectangular, or at least substantially rectangular, configuration, the roll-up door systems 10 can be stacked in one or more layers on the pallet and strapped to the pallet using one or more bands, for example. Owing to the rigidity of the hood assembly frames, the roll-up doors 12 are protected from being damaged by the straps when they are tightened to secure the roll-up door systems 10 to the pallet.

Although the various aspects of roll-up doors and roll-up door systems have been described herein in connection with certain disclosed aspects, many modifications and variations to those aspects may be implemented. Also, where materials are disclosed for certain components, other materials may be used in certain instances. Furthermore, according to various aspects, a single component may be replaced by multiple components, and multiple components may be replaced by a single component, to perform a given function or functions. The foregoing description and the appended claims are intended to cover all such modifications and variations as falling within the scope of the disclosed aspects.

While this invention has been described as having exemplary designs, the described invention may be further modified within the spirit and scope of the disclosure. This application is therefore intended to cover any variations, uses, or adaptations of the invention using its general principles.

Any patent, patent application, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A roll-up door system, comprising:
a hood assembly, comprising:
a first end panel;
a second end panel; and
support angles coupled to the first end panel and the second end panel;
an axle-drive assembly extending through the hood assembly; and
a roll-up door coupled to the axle-drive assembly, wherein the axle-drive assembly is rotatable relative to the hood assembly to transition the roll-up door between:
a stored state in which the roll-up door is wound around the axle-drive assembly within the hood assembly; and
a deployed state in which the roll-up door extends outside of the hood assembly.

2. The roll-up door system of claim 1, wherein the first end panel defines an opening, wherein the roll-up door system further comprises a bearing removably secured in the opening, and wherein the axle-drive assembly is rotatably supported by the bearing.

3. The roll-up door system of claim 2, wherein the first end panel comprises tabs surrounding the opening, and wherein the tabs are engaged with the bearing to secure the bearing in the opening.

4. The roll-up door system of claim 1, further comprising:
a first door guide configured to mount to a first side of an opening, wherein the first end panel is configured to couple to the first door guide; and
a second door guide configured to mount to a second side of an opening, wherein the second end panel is configured to couple to the second door guide.

5. The roll-up door system of claim 4, further comprising:
a first head stop configured to couple to the first door guide; and
a second head stop configured to couple to the second door guide.

6. The roll-up door system of claim 1, wherein the first end panel defines an opening, and wherein the roll-up door system comprises a grommet positioned in the opening.

7. The roll-up door system of claim 1, wherein the roll-up door comprises a first door panel and a second door panel removably coupled to the first door panel.

8. The roll-up door system of claim 1, wherein the axle-drive assembly comprises:
a shaft; and
collars removably coupled to the shaft, wherein the roll-up door is coupled to the collars.

9. The roll-up door system of claim 1, wherein the roll-up door comprises:
door panels comprising a lower-most door panel; and
a bottom bar removably coupled to the lower-most door panel.

10. The roll-up door system of claim 1, wherein the second end panel defines an opening, wherein the roll-up door system further comprises a tensioner extending through the opening, wherein the tensioner is coupled to the second end panel and the axle-drive assembly, and wherein the tensioner is configured to balance the roll-up door.

11. A kit, comprising:
a package, comprising:
a first door guide configured to mount to a first side of an opening; and
a second door guide configured to mount to a second side of the opening; and
a roll-up door system, wherein the roll-up door system comprises:
a frame configured to couple to the first door guide and the second door guide;
a shaft assembly extending within the frame; and
a roll-up door coupled to the shaft assembly, wherein the shaft assembly is rotatable relative to the frame to transition the roll-up door between:
a stored state in which the roll-up door is encompassed by the frame; and
a deployed state in which the roll-up door extends outside of the frame.

12. The kit of claim 11, further comprising a second package, comprising:
a first head stop configured to couple to the first door guide; and
a second head stop configured to couple to the second door guide.

13. The kit of claim 11, wherein the frame comprises:
a first end panel;
a second end panel; and
support angles coupled to the first end panel and the second end panel.

14. The kit of claim 13, wherein the first end panel defines an opening, and wherein the roll-up door system further comprises a bearing removably secured in the opening.

15. The kit of claim 14, wherein the first end panel comprises tabs surrounding the opening, and wherein the tabs are engaged with the bearing to removably secure the bearing in the opening.

16. The kit of claim 13, wherein the second end panel defines an opening, wherein the roll-up door system further comprises a tensioner extending through the opening, wherein the tensioner is coupled to the second end panel and the shaft assembly, and wherein the tensioner is configured to balance the roll-up door.

17. The kit of claim 11, wherein the roll-up door comprises a first door panel and a second door panel removably coupled to the first door panel.

18. A roll-up door system, comprising:
a hood comprising a hood frame;
an axle rotatably supported within the hood frame; and
a roll-up door coupled to the axle, wherein the axle is rotatable to transition the roll-up door between:
a stored state in which the roll-up door is wound around the axle within the hood frame; and
a deployed state in which the roll-up door extends outside of the hood frame.

19. The roll-up door system of claim 18, wherein the roll-up door is entirely positioned within the hood frame when the roll-up door is in the stored state.

20. The roll-up door system of claim 18, further comprising:
a first door guide configured to mount to a first side of an opening; and
a second door guide configured to mount to a second side of an opening;
wherein the hood frame is configured to couple to the first door guide and the second door guide.
